(19) United States
(12) Patent Application Publication
(10) Pub. No.: US 2014/0278909 A1
(43) Pub. Date: Sep. 18, 2014

(54) SYSTEM AND METHOD FOR REDACTION OF IDENTIFICATION DATA IN ELECTRONIC MAIL MESSAGES

(71) Applicant: RETURN PATH, INC, New York, NY (US)

(72) Inventors: Robert S. POTTER, Austin, TX (US); Bradford J. FULTS, Austin, TX (US)

(73) Assignee: Return Path, Inc, New York, NY (US)

(21) Appl. No.: 13/833,715

(22) Filed: Mar. 15, 2013

(51) Int. Cl. G06Q 30/02

(52) U.S. Cl. CPC G06Q 30/0242
USPC 705/14.41

(57) ABSTRACT

A system and method redacts information from messages, and especially messages of an email campaign. The system receives a plurality of campaign reports, each campaign report including campaign data associated with the email campaign. The system redacts information from the campaign data, such as personal information of one or more recipients of the email campaign.

### RELATED APPLICATIONS

This application includes subject matter related to commonly owned U.S. application Ser. No. 13/538,518, filed Jun. 29, 2012 to the present Assignee, the entire contents of which being incorporated herein by reference.

### BACKGROUND OF THE INVENTION

1. Field of the Invention

The present invention relates to electronic mailbox measurement. More particularly, the present invention relates to redaction of identification data in electronic mailbox measurement.

2. Background of the Related Art

Email campaigns are widely used by established companies with legitimate purposes and responsible email practices to advertise, market, promote, or provide existing customers with information related to one or more products, services, events, etc. Such email campaigns may be used for commercial or non-commercial purposes. They can be targeted to a specific set of recipients, and to a particular goal, such as increasing sales volume or increasing donations.

It is a desire of email campaign managers, and others who initiate email campaigns, for sent messages to be ultimately delivered to the intended message recipients. U.S. patent application Ser. No. 13/449,153, which is incorporated herein by reference in its entirety, describes a system and method for monitoring the deliverability of email messages (i.e., whether or not sent messages are ultimately delivered to intended message recipients).

It is a further desire of campaign managers to design campaigns that incite a maximum level of engagement by recipients of the email messages associated with each campaign. For example, campaign managers endeavor to increase the amount of campaign related messages that are read by recipients, the amount of messages that are forwarded by recipients, the amount of links within messages that are followed by recipients, and the amount of recipients that prioritize messages associated with various campaigns. To maximize engagement, campaign managers rely on practices such as carefully composing the subjects and contents of campaign-related messages, carefully selecting the time at which messages are sent, choosing the frequency at which messages are sent, and targeting campaigns to select groups of recipients.

To assist campaign managers in maximizing the effectiveness of email campaigns, there exists a need to provide campaign managers with a system and method to evaluate the effectiveness of campaigns, based on the recipients' level of engagement with each campaign. In particular, there exists a need to provide campaign managers with a system and method to compare the performances of multiple email campaigns with one another, so that the campaign managers may tailor the practices they use to increase recipient engagement with a particular campaign, based on that campaign's performance relative to other campaigns. Commonly owned U.S. application Ser. No. 13/538,518, filed Jun. 29, 20012, which is incorporated herein by reference in its entirety, provides a system and method for collecting data related to recipients' level of engagement with email campaigns.

There exists a need to provide a system and method to redact certain information, such as personal and/or private information, when evaluating and reporting the effectiveness of email campaigns.

### SUMMARY OF THE INVENTION

Accordingly, it is an object of the invention to provide a system and method for redacting information from email messages. It is a further object of the invention to remove personal recipient information from email messages that are provided to a third party, such as for marketing and evaluation purposes. It is a yet another object of the invention to provide a system and method for redacting personal identification information from email messages of an email campaign that are analyzed for message processing data.

A system and method redacts information from messages, and especially messages of an email campaign. The system receives a plurality of campaign reports, each campaign report including campaign data associated with the email campaign. The system redacts information from the campaign data, such as personal information of one or more recipients of the email campaign.

These and other objects of the invention, as well as many of the intended advantages thereof, will become more readily apparent when reference is made to the following description, taken in conjunction with the accompanying drawings.

### BRIEF DESCRIPTION OF THE FIGURES

FIG. 1 is an illustration showing an overview of a system in accordance with an exemplary embodiment of the invention;

FIG. 2 is a flow diagram showing steps in a process for electronic mail measurement in accordance with an exemplary embodiment of the invention;

FIG. 3 is a flow diagram showing steps in a process for message body redaction in accordance with an exemplary embodiment of the invention;

FIGS. 4(a), 4(c) are graphic displays of a user interface with an unredacted message body in an exemplary embodiment for processing by the present invention;

FIGS. 4(b), 4(d) are graphic displays of a user interface with a redacted message body in accordance with an exemplary embodiment of FIGS. 4(a), 4(c), respectively;

FIG. 5 is a flow diagram showing steps in a process for message subject line redaction in accordance with an exemplary embodiment of the invention;

FIG. 6 shows an example subject line redaction process; and

FIG. 7 is a graphic display of a user interface with redacted message subject lines in accordance with an exemplary embodiment of the invention.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose. Several preferred embodiments of the invention are described for illustrative purposes, it being understood that the invention may be embodied in other forms not specifically shown in the drawings.

The system and method of the present invention is implemented by computer software that permits the accessing of data from an electronic information source. The software and the information in accordance with the invention may be within a single, free-standing computer or it may be in a central computer networked to a group of other computers or other electronic devices. The information may be stored on a computer hard drive, on a CD ROM disk or on any other appropriate data storage device.

Turning to the drawings, FIG. 1 depicts a general overview of a non-limiting illustrative embodiment of a system 10 in which the invention can operate. The overall system 10 includes sending servers 101, client computers 102, data collectors 103, a FTP server 104, an analytics cluster 105, a database server 106, a web server 107, and a campaign manager 108. Preferably, communication between servers 101, client computers 102, data collectors 103, and FTP server 104 is via a network 109. However, each of the connections between the components of the system 10 can be a direct connection and/or a network connection via a wired or wireless network 109.

Each of the components of the system 10 (including the sending servers 101, client computers 102, data collectors 103, FTP server 104, analytics cluster 105, database server 106, web server 107, and devices used by the campaign manager 108) may be implemented by a computer or computing device having one or more processors to perform various functions and operations in accordance with the invention. The computer or computing device may be, for example, a mobile device (such as a smart phone), personal computer (PC), server, or mainframe computer. In addition to the processor, the computer hardware may include one or more of a wide variety of components or subsystems including, for example, a co-processor, input devices (such as a keyboard, touchscreen, and/or mouse), display device (such as a monitor or screen), and a memory or storage device such as a database. All or parts of the system 10 and processes can be implemented at the processor by software or other machine executable instructions which may be stored on or read from computer-readable media for performing the processes described. Unless indicated otherwise, the process is preferably implemented automatically by the processor in real time without delay. Computer readable media may include, for example, hard disks, floppy disks, memory sticks, DVDs, CDs, downloadable files, read-only memory (ROM), or random-access memory (RAM).

As illustrated in FIG. 1, the FTP server 104, analytics cluster 105, database server 106, and web server 107 may form a centralized measurement center 100 in accordance with the invention. The measurement center 100 may be remotely located from, but in communication with, the data collectors 103 and/or the campaign manager 108 through a network 109, such as the Internet, or in direct wired or wireless communication with the data collectors 103 and/or the campaign manager 108. The measurement center 100 may communicate with multiple, independent data collectors 103 to obtain data, and combine the data to create one singular view of the data.

Although in FIG. 1 the elements 101-108 are shown as separate components, two or more of those elements may be combined together. For example, the measurement center 100 may be one integrated system of components 104-107, and may also include one or more data collectors 103. The arrows in FIG. 1 depict a preferred direction of data flow within the system 10.

An exemplary non-limiting illustrative embodiment of the system 10 operates in accordance with the flow diagram 200 shown in FIG. 2. First, at step 201, an email campaign is created and deployed by any number of commercial mailers via an in-house email deployment system, or a third party Email Service Provider (ESP). The email campaign includes one or more email messages, each of which can be sent to a large number of recipients. Accordingly, each email message may be referred to as a “bulk email message.” The email message may include a subject line directed to encouraging recipient engagement with the message, and a body directed to soliciting business from the recipient. The email message may further include a campaign ID header to uniquely identify the email campaign with which the email message is associated. The campaign ID header may or may not be viewable by the individual recipients of the email message. The email message may be sent via a sending server 101 at one time, or in batches, as shown in FIG. 1.

At step 202, recipient mail clients receive the email message associated with the email campaign. If the message successfully reaches a recipient, the recipient may view the message on a client computer 102 via, for example, a webmail, desktop, or mobile email client. The set of all recipients includes a subset of panel recipients, wherein the usage activity of the panel recipients is considered representative of the usage activity of all recipients. Each panel recipient's mail client is equipped with one of several third party add-ons to the email client. Such add-ons allow for anonymous recording of the recipient's usage activity regarding mailbox placement and interaction with messages. Recipients interact with the received campaign email messages as they normally would. Such interactions may include, for example, opening messages, reading messages, deleting messages either before or after reading them, adding the sender of a message to the recipient's personal address book, forwarding messages, and clicking on links within messages.

At step 203, the data collectors 103, which may be operated by the providers of the third party add-ons, collect metrics associated with the recipient interactions. The collection of such metrics may be facilitated by the add-ons, which record recipient usage activity at the client computers 102 and transmit the recorded information to the data collectors 103 via the network. Preferably, each data collector 103 is an independent entity. Each data collector 103 aggregates the collected metrics by campaign to produce a campaign report, which includes campaign data, for each specific campaign. Campaign data may include message receive date, message receive time, subject line, sender domain name, sender user name, originating IP addresses, campaign ID header, and all of the associated mailbox placement and interaction metrics. The campaign reports produced by the data collectors may take on any appropriate format, provided the campaign reports are capable of being read by the measurement center 100. For example, the campaign reports may be tab delimited files, multiple SQL dump files, XML files, etc. When multiple data collectors 103 produce campaign reports having differing formats, the measurement center 100 may employ panel data and campaign rollup logic.

At step 204, each of the data collectors 103 transmits one or more individual campaign reports to a secure server 104 via sFTP or some other similar secure protocol. At step 205, the individual campaign reports are transferred from the secure server 104 to an analytics cluster 105 where the following process occurs. Utilizing the unique combination of campaign data (e.g., message receive date, message receive time, subject line, sender domain name, sender user name, originating IP addresses, and campaign ID (which is included in the campaign ID header)) from each of the multiple individual campaign reports received from the data collectors 103, the analytics cluster 105 identifies which campaign data from each campaign report pertains to each of one or more campaigns. For example, the analytics cluster 105 may determine that certain campaign data received from different data collectors 103 pertains to the same campaign, because the campaign data is associated with the same campaign ID. Thus, one report can contain data attributed to one or more campaigns, and data for one campaign may be obtained from one or more reports.

The analytics cluster 105 aggregates the like interaction metrics from each of the individual campaign reports for each of the campaigns. For example in a system 10 with two data collectors 103, a first data collector 103 may report that twenty recipients read an email message having a particular campaign ID, and a second data collector 103 may report that ten recipients read an email message having the same campaign ID. Thus, the analytics cluster 105 would aggregate the interaction metrics from the individual reports to determine that a total of thirty recipients read the email message. Data from each of the campaigns is included in a single report generated by the analytics cluster 105, the single report providing campaign performance statistics for all of the email campaigns having messages received by the recipients reporting to the data collectors 103.

In one non-limiting illustrative embodiment, a benchmarking process is run utilizing a statistical model for testing similarity that generates an engagement score based on recipients' engagement with each of the campaigns observed by the data collectors 103. In an exemplary embodiment of the invention, the model assigns weighted rankings to the following variables to benchmark engagement: amount of messages placed in inbox, amount of messages placed in spam folder by ISP, amount of messages placed in spam folder by recipient, amount of messages rescued from spam folder by recipient, amount of messages placed in a priority inbox or similar folders for ISPs that have them (e.g., Gmail priority inbox), amount of messages for which the sender is added to a personal address book, amount of messages opened, amount of messages read, amount of messages deleted without being read, amount of messages forwarded, amount of messages replied to, and the amount of messages for which recipients do not interact with the message at all.

The analytics cluster 105 uses the weighted ranking of each of the interaction metrics for each individual campaign to generate an engagement score for the campaign. Some interaction metrics, such as the amount of messages read, may be weighted more heavily than other interaction metrics. Furthermore, the relative weights of the interaction metrics may be modified, as appropriate, in accordance with the invention. Preferably, all interaction metrics reported by the data collectors 103 are considered by the analytics cluster 105. In addition, the interaction metrics that may be considered are not limited to the exemplary interaction metrics discussed herein.

An exemplary embodiment of the invention determines and assigns an engagement score and an engagement ranking to each individual campaign. The engagement score provides an indication of the recipients' engagement with the campaign. The engagement ranking provides an indication of the recipients' engagement with the particular campaign as compared to the recipients' overall engagement with all campaign email messages received. The engagement score may be, for example, a numerical value between 0 and 1, and the engagement ranking may be an integer value from 1 to 5. Each campaign is assigned an engagement benchmark based on the engagement ranking. For example, a campaign with an engagement ranking of 1 may be assigned an engagement benchmark of “poor,” and a campaign with an engagement ranking of 5 may be assigned an engagement benchmark of “excellent.”

### Message Body Redaction

FIG. 3 is a flow diagram showing steps in a process for message body redaction in accordance with an exemplary embodiment of the invention. Message body redaction may be implemented, for instance, at any one or more of steps 202-207 of FIG. 2. Though the message body redaction is discussed with respect email message campaigns where message statistics are tracked, it can be implemented in other suitable systems and message statistics need not be tracked. Message body redaction can be implemented at the data collector 103, or at a logically separate set of processors located between the data collector 103 and the FTP server 104. The redaction processors can be part of the measurement center 100 or separate and communicate with the data collector 103 and/or FTP server 104 via the Internet 109.

In step 301, candidate email messages of a particular email campaign are received from different user accounts by the data collectors 103. This can occur, for instance, at step 203 of FIG. 2 by the data collectors 103. The candidate email messages can be from various sources selected by one or more data collectors 103 from, e.g., Yahoo!, Gmail, or Outlook. The list of candidate messages is collected based on a predetermined whitelist (containing message senders (FROM addresses) and either an email campaign ID or the subject line) embedded as an email header. The whitelist is stored on the data collectors 103 and is kept up to date via periodic updates from the customer-facing inbox monitoring product. A “candidate message” is a message that matches a line on the whitelist—thus, it is a candidate for later redaction. It is noted that although a whitelist is used to collect candidate messages, any suitable technique can be used. Or, all messages can be considered candidate messages.

For example, a collection whitelist may contain “info@vanguard.com” (sender) and “V-2012-08-11-1A” (campaign ID) or “Your transaction confirmation is ready” (subject line), in which case all email messages are collected that match those criteria in step 301, as in the candidate messages shown in FIGS. 4(a), 4(c).

A minimum number of email messages per campaign must be collected from step 301 for the process to continue. In the preferred embodiment, a minimum of 3 messages per campaign is needed since at least 3 different messages are needed to note the differences between them. If only 1 or 2 messages are collected, the differences between them could be incidental rather than instructive for redaction (i.e. the differences might not actually be personal identification information).

In step 303, the email messages are organized into one or more clusters based on message structure, message size, and/or message similarity. According to one embodiment, emails can be hierarchically clustered first based on message structure, then based on message size, and then based on message similarity. Message similarity can be determined based on longest common sub-strings. Clustering of candidate messages is conducted to separate different message content across the candidate list of messages, which have the same subject line or campaign ID, but different content. For example, the sender (which can be a social website such as LinkedIn) may send 500 emails with subject line “Reconnect with Your Business Contacts” with email content suggesting 3 business contacts to recipients. The sender may then also send 500 different emails with the same subject line but with email content suggesting 5 business contacts. The message clustering would separate these two groups into two candidate sets for redaction.

Message structure can be determined based on one or more of the presence of headers, the presence and/or number of attachments, and/or the message body. In cases as the LinkedIn example above, where two sets of messages share a sender and subject line, but differ in content, clustering groups those messages into sets sharing the most common attributes, including the email headers, presence and/or number of attachments and similarity of the message bodies. These sets of messages are separated only in the computer memory (whether at the data collector 103 or the separate processors) and each set is prepared separately for its own redaction process in step 305.

In step 305, within each cluster, each email is compared to the first email in the set and common text is detected and identified using a suitable common subsequence algorithm, such as the Hunt-Mcllroy longest common subsequence algorithm, (http://en.wikipedia.org/wiki/Hunt % E2%80%93Mcllroy_algorithm, the content of which is herein incorporated by reference). Every email in the list is compared to the first one, each pair at a time, in succession. Because this algorithm uses a character-by-character comparison of two strings of text, “common text” is only that text which is exactly the same in both message bodies.

In step 307, once the strings of common text between two emails are identified from step 305, the remainder of the text (the uncommon parts) are replaced with redaction characters (“*” or a block of black background, as seen in FIG. 4(a) and FIG. 4(d)). Because the redaction treats HTML emails as text, the redaction step may also remove URLs, or images, and replace all removed information with a black box, underlined space, or the like.

Clustering is an optimization based on real-world client behavior. Some clients may send multiple different sets of content under the same campaign ID or subject line. This means that when a list of messages is collected “in a campaign” it may, in reality, be several content-driven campaigns masquerading under the same campaign identifier. Thus, clustering the messages sorts these different content sets out from one another, such that each candidate set of messages is then truly only those that share all content structure except personal identification information that will be redacted.

The list of messages (bits in memory) is passed through a clustering algorithm, which splits that list into new lists of content-grouped messages (several different sets of bits in memory). There's no need for a cluster ID, because this all happens within the same process and the data simply lives in computer memory while it is needed.

FIGS. 4(b) and 4(d) are graphic displays of a user interface with a redacted message body in accordance with non-limiting exemplary embodiments of the invention. FIG. 4(b) shows a campaign email example regarding confirmation of a financial transaction. The campaign email shown in FIG. 4(b) is personalized for a particular recipient by including their first and last name in the greeting line of the email body after “Dear”—such as “Dear Jane Smith” in the example of FIG. 4(a). That personal identification information can be identified by comparing several candidate emails of this email campaign, since the text corresponding to that personal identification (such as the recipient's name) appears much less frequently than the common text (such as “Hi” or “Dear”) in the campaign emails which repeats in each email. Once such uncommon text is identified (the recipient's first name in the embodiments shown), it can be redacted from the body of the message as shown in FIG. 4(b) (as compared to the original message in FIG. 4(a)).

FIGS. 4(c) and 4(d) show another campaign email example regarding a professional networking website. In FIG. 4(c) the campaign email is personalized for a particular recipient by including their first name in the greeting line of the email body—shown as “Benjamin” in the example of FIG. 4(c). That personal identification information has been identified as uncommon text and therefore redacted from the body of the message as shown in FIG. 4(d). Likewise, the terms Forever New and Retail are redacted as being personal identification information. In the LinkedIn example above, any personal contacts would be redacted from the body since they would vary from recipient to recipient, which would mark them as redactable content.

### Subject Line Redaction

FIG. 5 is a flow diagram showing steps in a process for message subject line redaction in accordance with an exemplary embodiment of the invention. Message subject line redaction may be included in step 203 of the process of FIG. 2.

In step 501, the process accepts a number of similar subject lines from a previously determined set of messages in a campaign, again grouped by both sender and either subject line or campaign ID. Due to the comparatively small amount of content in a subject line, at least 10 messages from at least 5 distinct user email accounts are required to continue the redaction process. This is needed since a mathematical frequency is utilized for the threshold. For instance, say our threshold is 0.2 and we only have 3 messages. If a word that happens to be personal identification information appears in the subject of only 1 of those messages, it will have a frequency of 0.33, which is greater than our threshold and thus it wouldn't be redacted. Having at least 10 messages from at least 5 distinct user email accounts avoids that issue. Message sets that don't have enough messages can be removed from the analysis altogether.

In step 503, each subject line in a candidate set (i.e., the set of all messages that matched the whitelist and are being used for redaction) is broken into individual words in order to allow comparison of the frequency of each word in the full set. In step 505, a measure of occurrence is determined for each word within the corpus of subject lines. According to one embodiment, the measure of occurrence is the normalized number of times a word appears within the corpus of subject lines; in other words, the number of times that a single word appears, divided by the total number of subject lines in the set.

In step 507, the words with a measure of occurrence below a pre-determined threshold are removed from each subject line and/or replaced with a pre-determined character. This threshold is necessary because it indicates the number of email messages that contain an individual word in the subject line is reflective of whether or not that word is personal identification information that should be redacted. Personal identification information is, by its nature, a rare occurrence in the context of an entire campaign, thus making this frequency analysis an appropriate fit for its redaction. For example, if a sender sends a campaign of emails to its customers with a subject line like “Hey Joe, 50% off All Electronics”, the frequency of every word except “Joe” will be 100% across the entire set of messages in the campaign, whereas the frequency of the word “Joe” will be less than 100%, and less than the pre-determined threshold, and will thus be redacted.

According to one embodiment, the pre-determined threshold is determined based on prior experimentation. These experiments involve running this subject line redaction process on several campaigns of email messages and having a human inspect the redacted results until the point at which all identification information is removed from all sets of subject lines. According to one embodiment, the threshold for all campaigns can be 0.1 (10%), but this could range anywhere from 0.001 to 0.3, depending on the data and usage.

It is noted that message body redaction is performed by comparing messages to each other, whereas subject line redaction is performed by determining the frequency of words in the subject. This is due to the differences between the data that message body redaction a much more difficult problem that needs to be solved in different ways. Though it may not be optimal, message body redaction can use a word frequency analysis, and subject line redaction can use a comparison technique.

Next, an example subject line redaction process is described with reference to FIG. 6 which corresponds to a particular email campaign. At step 602, candidate email messages are received from different user accounts by the message collectors 103 for a particular email campaign. This can occur, for instance, at step 203 of FIG. 2 by the email collectors 103 (step 501 of FIG. 5). In the example shown in FIG. 6, each email belonging to this email campaign has a subject line that starts with a recipient's first name followed by “, Save 50% on All Ebooks & Videos”. So, the subject line 604a to one recipient may read “Brad, Save 50% on All Ebooks & Videos”, while the subject line 604b to another recipient may read “Bob, Save 50% on All Ebooks & Videos.”

After receiving the emails, each subject line is split into “word atoms” (step 503 of FIG. 5), step 606. The word atom is the word itself along with its starting position in the subject line and frequency information. A table with entries 608 is then compiled that includes position and count information corresponding to each word (as in step 505 of FIG. 5). The starting position of a word is determined by counting off the number of characters from the beginning of the line to the beginning of the word. There is no requirement that the same word share starting positions with other instances of that word throughout the set, as the position is only used for reassembly of the subject line at step 614, once the redaction is complete.

Thus, the message recipient's name in each of the entries 608a, b is at position 0 in the subject line. In the present example, the first word after the recipient's name is “Save”. As shown in entry 608e, the word “Save” has a position of 6. Each subject line has its own set of words with their position. So if there are 15962 subject lines (as in the example shown), there will be 15962 copies of “Save” and its corresponding position in each of those subject lines. However, the system recognizes that those 15962 copies are for the same term “Save” and consolidates those to a single entry for “Save”. The position “6” is shown even though the 15962 copies could have a range of positions. The position indicates that the term “Save” is the next term to be displayed after the name. And, the position “11” for “50%” indicates that the term “50%” is the next term to be displayed after the term “Save”.

Thereafter at step 610, any words that have a frequency less than a predefined threshold are redacted (step 507 of FIG. 5). In the example of FIG. 6, all common words, such as “Save” 608e, 612e, have a count of 15962 and a frequency of 100%, meaning that those words appear in all (or substantially all) of the messages and therefore are unlikely to be identification information. The Result is that those common words are retained, such that the term “Save” is the Result for entry 612e. On the other hand, all uncommon words have a frequency that is significantly lower than 15962. For instance, the words “Brad,” “Bob,” “Dave,” and “Sarah,” have respective counts of 2, 68, 147, 361 (entries 608a-d) and frequencies of 0.0001%, 0.004%, 0.009% and 0.023% (entries 612a-d), which means that those words are uncommon since they appear in substantially less than the 15962 total messages. Therefore those uncommon terms are identification information and the Result is that those terms are replaced with a redaction character such as “_”, as shown at entries 612a-d. Accordingly, an appropriate threshold can be determined based on prior experimentation.

Finally at step 614, a redacted subject line 616 is reassembled from the redacted word atoms by replacing the redacted word with a character such as “_”. An example of the resulting redacted subject line is “_{—} Save 50% on All Ebooks & Videos” as shown in FIG. 6. The messages are reassembled based on the relative positioning from FIG. 6(b). That is, that the name is the first term to be displayed, the term “Save” is the second term, the term “50%” is the next term to be displayed, and so on.

We reassemble the string in position order, including redactions. For instance, if the subject was “Save 50%, Brad”, we would have the following words split out with example counts: (0, “Save”, 15962); (5, “50%”, 15962); (9, “Brad”, 123). So, “Brad” would be redacted because its frequency (123/15962) is less than the threshold (0.1), which leaves this result: (0, “Save”, 15962); (5, “50%”, 15962); (9, “_{—}”, 123). Then the words are reassembled in order by position: “Save”+“50%”+“_”. If the redaction had taken place in the middle of the subject, it would just take the place of the previous word, e.g. “Hey”+“_”+“Check”+“Out”+“Our”+“Deals”. Thus, the words are sorted by their starting position and reassembled after the redaction analysis.

FIG. 7 shows a graphic display of a user interface with redacted message subject lines in accordance with an exemplary embodiment of the invention. The example redacted subject lines shown in FIG. 7 correspond to several different groups of subject lines, e.g., “_{—} See who you know from Yahoo on LinkedIn” and “_{—} people are viewing your profile”. As shown in FIG. 7, within each group of subject lines, personal identification such as first names are replaced with a “_” character, thereby being redacted.

FIG. 7 shows an example of the redacted subject lines being passed off to the end user viewing, step 207. Both the redacted messages and redacted subject lines are handed off from the data collectors/redactors 103 to the system in 104, 105, 106, 107 before being consumed by the end user 108. In an illustrative embodiment, the results of one or more message campaigns can be displayed in a display area 700 of a display device. As shown, all of the campaigns are from a single sender, in this case a social network such as LinkedIn. The redacted messages 702a-j are each from a different email campaign. For instance, the first message 702a results from a message campaign initiated on Nov. 1, 2012 using the subject line “_with peers from_Industry”. As shown, that subject line resulted in two redacted terms 704a, b. The first redacted term 704a was likely a person's name and the second redacted term 704b was likely the person's company or profession. However, because the person's name and company/profession are personal identification information, that information has to be redacted in order for the email message itself to be viewed by third parties and used for marketing or sales purposes or to improve the success or impact of future email campaigns.

As further shown in FIG. 7, the email campaigns 702 can be repeated on different dates. For instance, campaigns 702g-j all have the same subject line “_See who you know from Yahoo on LinkedIn.” However, they are from different campaigns since they were initiated on different dates. In addition, it should be noted that the user (LinkedIn in this example) can select any one of the campaign subject lines to drill down and see the full email message itself (as redacted), such as those shown in FIGS. 4(b) and 4(d). And, the user can also optionally be provided with the analytics of one or more message campaigns 702. For instance, the analytics might include the number of times messages were deleted without being read, saved, and/or a link was accessed by the recipient, as provided for in U.S. application Ser. Nos. 13/538,518 and 13/449,153 to the present Assignee, the content of which is hereby incorporated by reference.

It should be noted, however, that any set of email messages with similar templated content, differing only in their use of private identifiable information, could be put through these same redaction processes. Email campaigns are just one such class of possible sets of emails that can be redacted in this manner. In addition, according to one embodiment, any of the processes described herein may additionally include removing information within an email header. Unless otherwise stated, the steps performed herein are all performed automatically in real-time by the processor, without manual interaction.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A method for redacting personal identification information from an email campaign or other group of email messages sharing content structure, the method comprising the steps of:
receiving a plurality of campaign reports, each campaign report including campaign data associated with a plurality of email messages from the email campaign; and
redacting information from the plurality of email messages, the information including personal information of one or more recipients of the plurality of email messages.

2. The method of claim 1, further comprising combining the campaign data from the plurality reports to produce a single report corresponding to the email campaign.

3. The method of claim 1, wherein the campaign data includes at least one of: subject, sender domain name, sender user name, and campaign ID.

4. The method of claim 1, wherein the campaign data includes a plurality of email messages each having a subject line, and the step of redacting information from the campaign data comprises redacting information from the subject line.

5. The method of claim 4, wherein the subject line has a plurality of text, and wherein the step of redacting information from the subject line comprises:
determining the frequency of each word in the plurality of text; and
redacting the words based on the determined frequency.

6. The method of claim 5, further comprising replacing the redacted uncommon text with a redaction character.

7. The method of claim 1, wherein the campaign data includes email messages each having a body, and the step of redacting information from the campaign data further comprises redacting information from the body.

8. The method of claim 7, wherein the body has a plurality of text, and wherein the step of redacting information from the body comprises:
comparing the plurality of text of at least two of the email messages to determine at least one common text and at least one uncommon text from each of the plurality of email messages; and
redacting at least one uncommon text from the body of each of the plurality of email messages.

9. The method of claim 8, further comprising replacing the redacted uncommon text with a redaction character.

10. The method of claim 9, wherein the redaction character comprises a black box.

11. A system for evaluating the effectiveness of an email campaign, the system comprising:
a secure server configured to receive campaign data;
an analytics cluster configured to:
receive a series of email messages from a single email campaign,
redact information from the email messages, the information including personal information of one or more recipients of the email campaign,
combine the email messages from the plurality of reports to produce a single report corresponding to the email campaign,
a database server configured to store campaign data; and
a web server configured to present campaign data to an end user.

12. The system of claim 11 further comprising at least one data collector configured to collect campaign data and send the campaign data to the secure server.

13. The system of claim 11, wherein the campaign data includes interaction metrics and at least one of: message receive date, message receive time, subject, sender domain name, sender user name, originating IP address, and campaign ID.

14. A system for providing information about a plurality of email messages sharing content structure, each of the plurality of email messages sent to an individual recipient through one or more internet service providers (ISPs), the system comprising:
a processor configured to receive the plurality of email messages received by the ISPs, identify the plurality of email messages as sharing content structure, and redact personal identification information from the plurality of email messages.

15. The system of claim 14, wherein the plurality of email messages each have a subject line, and said processor is configured to redact personal identification information from the subject line.

16. The system of claim 15, wherein the subject line has a plurality of text, and said processor is configured to redact personal identification information from the subject line by determining the frequency of each word in the plurality of text; and redacting the words based on the determined frequency.

17. The system of claim 16, said processor further replacing the redacted uncommon text with a redaction character.

18. The system of claim 14, wherein the campaign data includes email messages each having a message body, and said processor is configured to redact personal information from the message body.

19. The system of claim 18, wherein the body has a plurality of text, and wherein said processor redacts personal identification information from the body by comparing the plurality of text of at least two of the email messages to determine at least one common text and at least one uncommon text from each of the plurality of email messages, and redacting at least one uncommon text from the body of each of the plurality of email messages.
